(19) United States
(12) Patent Application Publication
(10) Pub. No.: US 2026/0296975 A1
(43) Pub. Date: Oct. 1, 2026

(54) METHODS USING SLAG TO PROVIDE SUPPLEMENTARY CEMENTING MATERIAL AND CO2 SEQUESTRATION

(71) Applicant: Nucor Corporation, Charlotte, NC (US)

(72) Inventors: David W. Hendrickson, Hibbing, MN (US); Lindsay Leveen, Sausalito, CA (US)

(73) Assignee: Nucor Corporation, Charlotte, NC (US)

(21) Appl. No.: 19/630,132

(22) Filed: Mar. 26, 2026

Related U.S. Application Data
(60) Provisional application No. 63/778,907, filed on Mar. 27, 2025.

(51) Int. Cl. C04B 28/08; C04B 111/00

(52) U.S. Cl. CPC C04B 28/082; C04B 2111/00019

(57) ABSTRACT

Materials and methods for removing CO₂ from CO₂-comprising gas, e.g., stack gases from production of steel or hydrocarbon fuel combustion, air, are disclosed, which comprises exposing prepared slag to the CO₂-comprising gas. The disclosure also provides for an apparatus for exposing CO₂-comprising gas to slag and continuous processes of removing slag from a steel manufacturing process, contacting CO₂ from the CO₂-comprising gas with the slag, and directly capturing CO₂ and/or providing SCM material.

### CROSS-REFERENCE TO RELATED APPLICATIONS

This application claims the priority benefit of U.S. Provisional Application No. 63/778,907 filed on Mar. 27, 2025, the entirety of which is incorporated herein by reference.

### TECHNICAL FIELD

This disclosure is directed to using slag from a steel manufacturing process and methods of CO₂ sequestration using slag and/or the preparation and use of supplementary cementing material (SCM) from slag. In aspects, methods of CO₂ sequestration using slag and/or the preparation and use of supplementary cementing material (SCM) from slag are performed simultaneously or separately.

### BACKGROUND

Steel mills produce about 130 million tons of slag worldwide. Electrical Arc Furnace (EAF), Basic Oxygen Furnace (BOF) slags and ladle slags are the major types of steel slags produced in the steelmaking process. Currently, these steelmaking by-products are mainly marketed as aggregates for construction, including their use in asphalt pavement, roadbed construction, and concrete.

Although steel slag is rich in calcium, the use of steel slag as a cementing material is not common, as steel slag is neither a hydraulic nor a pozzolanic material, as it is lacking tri-calcium silicate compound and the amorphous silicon dioxide (SiO₂) content. The slag is typically land-filled or mixed with asphalt and used in road construction as an outcome from typical steel making process.

At least one process, the Carbon UpCycling Process, consists of the following process steps, where slag is ground to less than 44 microns using an air swept vertical roller mill. This finely ground slag is introduced into a large volume horizontal dry ball mill filled with 60° C.-90° C. heated CO₂-containing gas and a small number of mm sized steel balls for a residence time to form slag particles with calcium carbonate on the surface. This process is rate limited by the surface CaCO₂ coating step. However, the steel ball milling process used in the Carbon UpCycling Process is insufficient for large scale (tons per day) slag-to-SCM conversion processing due at least in part to the inherent hardness of the slag. For example, the present method using high intensity mixing provides for about 1 ton of slag to be CO2 mineralized in about 1-2 hrs vs about 4-6 hrs using horizontal reactors.

### SUMMARY

In examples, a process for providing supplementary cementing material from slag is provided, the process comprising: grinding slag to a plurality of slag particles having an average particle size of less than 50 microns; mixing the plurality of slag particles in the presence of a CO2 source gas; forming an amount of CaCO2 on at least a surface of the plurality of slag particles to provide CaCO2-surface coated slag particles; releasing at least a portion of the amount of CaCO2 from the CaCO2-surface coated slag particles to provide free CaCO2; and discharging the CaCO2-surface coated slag particles and free CaCO2.

In other examples, a system for direct capture of at least a portion of CO2 from a CO2-comprising gas is provided, the system comprising, in combination: (a) introducing a CO2-comprising gas to a slag; and (b) providing a reaction product of the slag with the CO2-comprising gas.

In yet other examples, an apparatus for providing SCM and/or removing at least a portion of CO2 from a CO2-comprising gas is provided, the apparatus comprising, in combination: (a) a device in which a CO2-comprising gas is introduced to a slag; and (b) a device for providing recovery of a reaction product of the slag with the CO2-comprising gas.

### BRIEF DESCRIPTION OF THE DRAWINGS

In order to understand and to see how the present disclosure may be carried out in practice, examples will now be described, by way of non-limiting examples only, with reference to the accompanying drawings, in which:

FIGS. 1A and 1B are schematic diagrams illustrating an exemplary process for removal of slag from a steel manufacturing process in accordance with the broadest aspect of the present disclosure.

FIG. 2 are schematic flow diagrams illustrating alternative, more specific steps of the process disclosed in FIG. 1.

FIGS. 3A, 3B, and 3C are depictions of direct CO₂ capture using slag in combination with transporting means.

FIG. 4 is a flowchart illustrating an exemplary process converting slag from a steel manufacturing process to SCM in accordance with the broadest aspect of the present disclosure.

FIG. 5 is another flowchart illustrating an exemplary process converting slag from a steel manufacturing process to SCM in accordance with the broadest aspect of the present disclosure.

FIG. 6 is a diagrammatic view of an exemplary process according to the present disclosure.

### DETAILED DESCRIPTION

The word “a” or “an” when used in conjunction with the term “comprising” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used in this specification and claim(s), the word “consisting” and its derivatives, are intended to be close-ended terms that specify the presence of stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±10% of the modified term if this deviation would not negate the meaning of the word it modifies.

“Steel slag” herein refers to the slag by-product produced from steel-making manufacturers. Steel slag is inclusive of slag produced from Basic Oxygen Furnaces (BOF). Steel slag may also include slag produced from Electric Arc Furnaces (EAF). EBH slag are also contemplated as useful herein and refers to EAF-BOF Hybrid, which is a type of steel slag formed of a mixture of EAF and BOF produced slags. Steel slag as used herein may further include ladle slag.

“Ladle slag” herein refers to a type of steel slag. Ladle slag is produced as a by-product from a ladle refining operation. In various steel making processes, molten steel produced in an EAF or BOF process undergoes an additional refining processes based on the quality of the desired steel. Additional fluxes and alloys are added to a ladle to remove the impurities within the steel and to produce steel with the desired properties. The reaction takes place in the presence of a slag in which the most significant oxides are SiO₂, Al₂O₂, CaO, and MgO. This operation is known as ladle refining, because it is executed in the transfer ladle. During this process, additional steel slags are generated, which are ladle slags. The chemical compositions of ladle slag are highly variable and different from the chemical compositions of BOF and EAF steel slags. In one example, ladle slag shows higher aluminum oxide content and lower iron oxide content as compared to BOF and EAF steel slags. Generally, ladle slags exhibit a calcium oxide to silica oxide ratio of about 2.

“EBH slag” herein refers to EAF-BOF Hybrid, which is a type of steel slag formed of a mixture of EAF and BOF produced slags. As used hereinafter, steel slag, ladle slag, and EBH slag are referred to collectively as “slag” unless otherwise specified.

It will be understood that “steel slag” as used herein excludes “iron slag” and “blast furnace slag” typically generated during iron production. Steel slag can be reactive with carbon dioxide as it is crystalline. In one example, steel slag containing high calcium silicates and low iron compounds is used in presently disclosed method rather than iron slag because iron slag, upon contact by water, forms an amorphous material that is not sufficiently reactive with CO₂.

“Gaseous mixture,” as used herein, encompasses any gas mixture with CO₂ present therein (hereinafter “CO₂-comprising gas”), for example, air. Air can be sourced from an ambient atmosphere in proximity to the source of the slag, e.g., a steel manufacturing facility, or from compressed air. In one example, the gaseous mixture is flue or exhaust gases from a steel manufacturing facility, alone or in combination with air sourced from an ambient atmosphere. In one example, CO₂-comprising gas is air from an ambient environment, previously captured air, and any gas mixture comprising CO₂.

“FeOx” as used herein is inclusive of ferrous oxides and ferric oxides, hydrates, and combinations thereof in any molar or mass quantity.

As used herein, the phrase “furnace stack gas” encompasses exhaust that exits a furnace after fuel is burned. Furnace stack gas typically contains carbon dioxide, water vapor, and small amounts of pollutants and unburned fuel. For example, a stack furnace that burns a hydrocarbon fuel source for heating steel components for subsequent processing in a steel mill would provide a source of furnace stack gas.

As used herein, the phrase “Supplementary Cementing Materials (SCMs) encompasses materials that when used with Portland cement provide improvement to one or more properties of the resultant hardened concrete. The improvement to the hardened concrete can include hydraulic, pozzolanic, or both. SCMs of the present disclosure include steel slag, ladle slag, EAF steel slag, and EBH slag. SCMs of the present disclosure can further include fly ash, ground granulated blast furnace slag (GGBFS) and silica fume.

Some EAF operations convert their EAF steel slag to ½ inch (12.7 mm) sized aggregates for road building. Because of its great mechanical efficiency and wear resistance, crushed steel slag has significant advantages when used as an aggregate.

By grinding slag to a fineness of 10 microns and reacting it with reheat furnace stack gas containing 4-5% CO₂, the slag can be converted to an SCM to the cement industry. Carbon credits can also be gained for CO₂ sequestration. CO₂ mineralization of EAF steel slag therefore represents economically sought after processes as the current reuse pathways of using crushed slag in road building are low value.

Two methods of EAF steel slag mineralization processes are commonly employed, direct and indirect mineralization via carbonation. Direct mineralization technologies are much closer to commercialization with full scale plant operations currently in use, than Indirect mineralization technologies.

Direct mineralization technologies provide for the ability of EAF steel slag to sequester 5%-12% by weigh of CO₂ per ton slag in producing SCMs. SCM's have been used to replace between 30-60% of Portland Cement in concrete with Portland Cement.

Finely ground uncarbonated EAF steel slag cannot be a direct replacement for cement in concrete due to its free lime (CaO) and magnesium oxide content, which can cause volumetric expansion and instability in concrete. In contrast, ground, granulated, quickly cooled blast furnace slag becomes amorphous and is sold directly a partial replacement for cement.

SCM's are sought after by the cement industry due to their lower cost as a partial cement replacement compared to Portland cement. SCM's also present the ability to avoid large scale CO₂ emissions when used as a partial cement replacement. The cement industry calcines limestone to produce “clinker” which is ground to produce Portland cement. Portland cement containing SCM's also produces enhanced concrete physical properties such as enhanced initial compressive strength and enhanced ultimate concrete compressive strength.

Producing EAF steel slag SCM's is therefore an effective strategy to improve solid waste utilization, minimize carbon emissions, and decrease cement clinker consumption.

In examples, the device may include grinding slag to a plurality of slag particles having an average particle size of less than 50 microns; mixing and heating the plurality of slag particles in the presence of a CO₂ source gas; forming an amount of CaCO₂ on at least a surface of the plurality of slag particles to provide CaCO₂-surface coated slag particles; releasing at least a portion of the amount of CaCO₂ from the CaCO₂-surface coated slag particles to provide free CaCO₂; and discharging the CaCO₂-surface coated slag particles and free CaCO₂. In one general aspect, process may include grinding slag to a plurality of slag particles having an average particle size of less than 50 microns; mixing and heating the plurality of slag particles in the presence of a CO₂ source gas; forming an amount of CaCO₂ on at least a surface of the plurality of slag particles to provide CaCO₂-surface coated slag particles; releasing at least a portion of the amount of CaCO₂ from the CaCO₂-surface coated slag particles to provide free CaCO₂; and discharging the CaCO₂-surface coated slag particles and free CaCO₂.

In one general aspect, system may include one or more apparatuses configured to: grind slag to a plurality of slag particles having an average particle size of less than 50 microns mix and heating the plurality of slag particles in the presence of a CO₂ source gas form an amount of CaCO₂ on at least a surface of the plurality of slag particles to provide CaCO₂-surface coated slag particles release at least a portion of the amount of CaCO₂ from the CaCO₂-surface coated slag particles to provide free CaCO₂; and discharge the CaCO₂-surface coated slag particles and free CaCO₂.

The present disclosure also provides for application of capturing CO₂ from air using steelmaking slag. Air is presented to the steelmaking slag The captured CO₂ can be sequestered or stored. Because of its high calcium content, slag can react with carbon dioxide (CO₂). For the carbon dioxide capture from air, a reaction is generally carried out between the slag and the CO₂ present in air.

Two methods of EAF steel slag mineralization processes are discussed in this review paper, direct and indirect mineralization via carbonation. Research is continuing with all of the processes as they move towards commercialization. Direct mineralization technologies will be the focus of this review as these technologies are much closer to commercialization with full scale plant operations currently in use, than Indirect mineralization technologies.

Direct mineralization technologies provide the ability of EAF steel slag to sequester about 5%-12% by weigh of CO₂ per ton slag in producing SCMs. The present disclosure provides an improved method whereby slag is introduced into a high pressure grind roll mill to produce slag particles having an average particle size of about 1-75 microns. The slag particles having an average particle size are then introduced into a rotating high intensity/pressure mixer. Stack gas is introduced to the high intensity/pressure mixer and allowed to mix with the dry, finely ground slag to form a CaCO₂ coating on the slag particles. In examples, the stack gas is reheated prior to introduction to the slag particles. In examples, (reheated) stack gas enters the top of the high intensity mixer and is pulled down into the mixing slag particles. In examples, stack gas that is not adsorbed by the slag leaves through a pressure relief valve. In examples, the high intensity of the mixing of slag particles grinds off the CaCO₂ coating, thus reducing the rate limiting surface CaCO₂ adsorbing/coating step.

In examples, direct carbonation reacts CO₂ from steelmaking stack gas and/or air with EAF steel slag in the presence of water (as vapor, steam, or liquid) to from SCM's in one reactor. Indirect carbonation separates the two processes as it extracts calcium and magnesium from EAF steel slag in water (as vapor, steam, or liquid) or other solvents first in one reactor, and then reacts CO₂ with the dissolved calcium and magnesium in the solvents in a separate reactor.

### Direct Carbonation (Gas Solid, Aqueous, Supercritical Routes)

In the gas-solid carbonation of slag route, the moisture level is typically below 0.2, indicating that solid minerals directly react with gaseous CO₂. The mineralogical phases commonly found in slags and dust lead to the following representative chemical reactions during mineral carbonation are know:

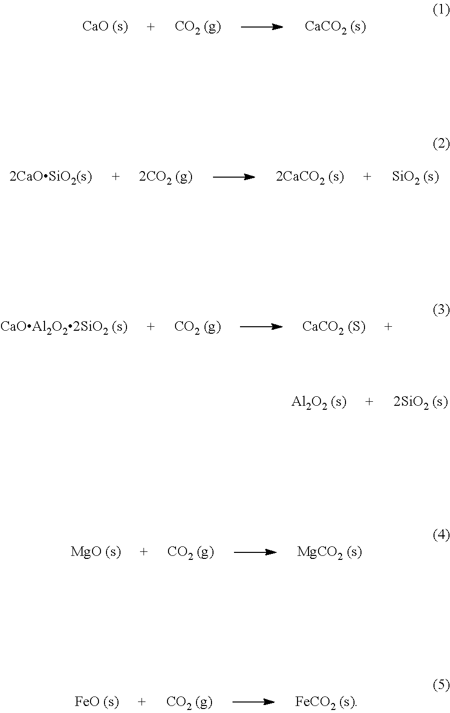

Because these reactions have negative Gibbs free energy under ambient conditions (25° C. and 1 atm), they are thermodynamically favored. However, some of the above reactions become nonspontaneous at higher temperatures. In addition, the gas-solid carbonation process is often limited by slow kinetics and slow diffusion, resulting in low carbonation efficiency and energy-intensive pretreatment/processing steps.

### Aqueous Carbonation

In contrast to the one-step gas-solid carbonation process, both aqueous and supercritical carbonation involve three steps:

(1) Dissolution of CO₂ into an aqueous solution; (2) Leaching of metal ions from the solid phase; and (3) Precipitation and crystal growth of metal carbonates.

In the first step, CO₂ dissolves into water, forming carbonic acid. Carbonic acid then dissociates into bicarbonate and carbonate ions with the degree of dissociation as a function of pH. The resulting hydrogen ions then lead to the dissolution of Ca- and Mg-bearing phases in iron and steel by-products (step 2), and the dissolved Ca and Mg ions further react with carbonate and bicarbonate ions from carbonic acid, forming calcium and magnesium carbonates (step 3).

The specific reactions involved in these steps are presented below, with dicalcium silicate (2CaO·SiO₂ or C₂S) used as an example. Reactions (6)-(9) correspond to step 1, Reaction (10) to step 2, and Reaction (11) to step 3. These reactions demonstrate the stepwise transformation of dicalcium silicate into calcium carbonate during the aqueous or supercritical carbonation process.

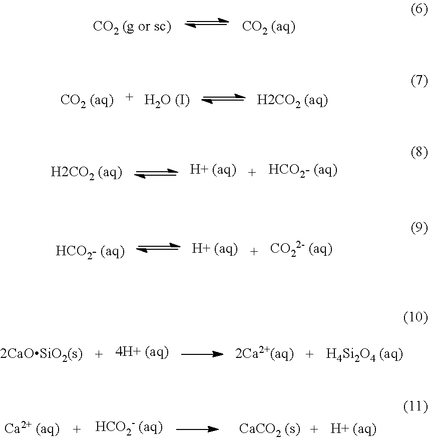

The solubility of CO₂ in aqueous solutions is a critical factor in the initial step of mineral carbonation, especially when the process occurs under extreme conditions involving high temperatures and pressures or the use of supercritical CO₂.

In aqueous or supercritical carbonation, the rate-determining step is usually the leaching of metal ions from the mineral matrix. In order to enhance the reaction kinetics, various techniques have been employed including the use of additives, fine grinding, vigorous stirring, ultrasonic agitation, and microwave irradiation.

### Indirect Carbonation

Indirect carbonation primarily involves two essential steps:

(1) leaching alkaline earth metal ions (e.g. Ca²⁺ and Mg²⁺) from the feedstock into an aqueous solution; and (2) carbonate precipitation (e.g. CaCO₂, MgCO₂, and (Ca,Mg)CO₂) through the reaction between dissolved alkaline earth metal ions and CO₂.

In examples, separation of leaching and precipitation processes occur in distinct reactors to generally yield higher carbonation efficiency compared to direct carbonation. Various extractants, such as organic and inorganic acids, ammonium salts, molten salts, sodium hydroxide, and brine, have been utilized for this purpose. While low pH is preferred to maximize the leaching of alkaline earth metal ions, it does impede the dissolution of CO₂ into the aqueous solution during the subsequent precipitation step, resulting in a low carbonation conversion rate. To address this limitation, pH swing indirect carbonation has been developed, involving adjusting the solution pH to low levels during the extraction step and then elevating it to high levels (near pH 10) during the precipitation step. This process has proven to possess the capability to produce high-purity products with remarkable carbonation conversion rates. Indirect carbonation necessitates the use of chemicals as extractants, leading to increased operating expenses.

As described above, direct gas-solid carbonation is a process where CO₂ gas reacts directly with solid metal oxides to produce carbonates. The specific reactions vary depending on the slag feedstock. Experimental results indicate that direct, gas-solid CO₂ mineralization can be achieved in about 1.0 hour at relatively high net CO₂ mineralization efficiencies, especially when slag has been slowly solidified and is crystalline. In contrast, indirect carbonation offers benefits in terms of the superior purity of the resulting product and is a more intricate process that may demand more energy due to the supplementary leaching step. Additionally, the challenges of recycling extractants contribute to increase costs in the carbon mineralization process. Thus, in examples, the present process excludes an indirect carbonation process.

During the carbonation of slag particles, carbonates are formed on the surface of the slag particles. Diffusion of reactants (calcium ions and CO₂ gas converted to carbonate CO₂ ions), through the product calcium carbonate layer overlaying slag particles is the primary rate-limiting factor for carbonization. There are 8 orders of magnitude differences in reactant ‘diffusivity’ between different slag minerals with several displaying complete passivation after only a few nanometers of mineralization.

Kinetics models of carbonation reaction based on surface coverage models shows that the reaction takes place exclusively at unreacted surface sites. In this model, phases containing calcium reacts with CO₂, forming calcium carbonate. As the reaction progresses the active surface area remains uncovered by reaction products until reaching maximum conversion. In the shrinking core model, an initially unreacted core progressively diminishes in size as the reaction proceeds. Furthermore, the creation of small calcite (calcium carbonate) crystals on the surface of the solid forms a protective layer that envelops the reactive particles and shields the particles from further reactions. Within the Shrinking Core Model, an initially unreacted core progressively diminishes in size as the reaction proceeds

Crystalline minerals in the EAF steel slag react with CO₂ to form amorphous SCMs. Calcium Oxide (free Lime) in the EAF steel slag reacts with CO₂ to form Calcite (CaCO₂) and Larnite, CasiO4 in the EAF steel slag reacts with CO₂ to Calcite (CaCO₂). These are the two primary calcium minerals in EAF steel slag that form Calcium Carbonate when carbonated in the presently disclosed process.

EAF steel slag, by example, provides for the sequester of about 5%-12% by weigh of CO₂ per ton slag in producing SCMs. Calcium carbonate crystals forms on the slag particles and can be continuously removed to create a continuous process of slag-to-calcium carbonate in the presently disclosed process.

In examples, achieving rapid CO₂ mineralization of slag is achieved by maintaining crystalline compounds within the slag with higher diffusion coefficients (typically ×10³-10⁵) relative to their chemically equivalent amorphous compounds. In examples, crystalline slags can be generated by a slow cooling processes during the steel production. In examples, highly crystalline slags increases absorption of CO₂.

In examples, the diffusivity of CO₂ through the slag and/or partially carbonated/mineralized slag particle is increased with higher relative humidity of the gas phase. Higher relative humidity generates faster CO₂ mineralization rates across a wide variety of compounds present in the slag. Advantageously, the various flue and stack furance gases available at an steelmaking plant, such as reheat furnace stack gas, contain sufficient water vapor to maintain saturated water vapor conditions at the temperatures used in direct, gas-solid CO₂ mineralization (e.g., about 30 to about 50° C.).

Literature data supports the increase in CO₂ Diffusivity (D) as a function of relative humidity (RH) for CaSiO₂ and MgO minerals in slag. Increasing the relative humidity in EAF steel slag carbonation leads to an exponential increase of D for crystalline CasiO₂.

### Slag Grinding

In examples, a high diffusivity of CO₂ through the slag coupled with grinding and provides an increased CO₂ mineralization rate. Amorphization, in general, should be avoided during the grinding of slag. Excessive grinding can reduce the overall CO₂ mineralization rate due to the reduction in diffusivity that comes with amorphization. In examples, EAF steel slag is sieved to isolate an average particle size suitable for subsequent grinding/milling. In examples, EAF steel slag is sieved to isolate an average particle size of 1-20 mm. In examples, EAF steel slag is sieved to isolate an average particle size of 1-20 mm and passed through a magnetic separator to remove ferrous material that can be recycled back to the EAF. Removal of ferrous material from the EAF slag also reduces wear on the grinding/milling equipment in subsequent processing.

Thus, in examples, grinding of the sieved EAF steel slag to an average particle size or average particle size distribution of between 10-50 μm (±1 μm) is performed using high-pressure grinding equipment. In examples, grinding of the sieved EAF steel slag to an average particle size or average particle size distribution of about 25 μm In such examples, an increase in the mineralization rate by a factor of about 10³ for ground/milled slag sized to about 25 μm can be achieved verses aggregated slag of >100 μm.

In examples, grinding of the slag to between 2-9 μm using high-pressure grinding equipment is used. In examples, grinding of the slag to between 3-8 μm using high-pressure grinding equipment is used. In examples, grinding of the slag to between 4-8 μm using high-pressure grinding equipment is used. In examples, grinding of the slag to between 5-8 μm using high-pressure grinding equipment is used. In examples, grinding of the slag to between 6-8 μm using high-pressure grinding equipment is used. In examples, grinding of the slag to a target average particle size of about 7 μm using high-pressure grinding equipment is used.

Slag grind sizing below 1 micron makes carbonation technologies physically and/or commercially impractical. In addition, overgrinding below 1 micron can convert crystalline slag minerals to amorphous compounds which do not economically absorb CO₂ efficiently.

Slag produced as a by-product of a steel making process can be used directly from the steel manufacturing equipment in a continuous process. In one example, slag and optional additional material is contacted with the gaseous mixture, e.g., air comprising carbon dioxide, resulting in reaction of the carbon dioxide with the slag and the removal of at least a portion of the carbon dioxide from the gaseous mixture.

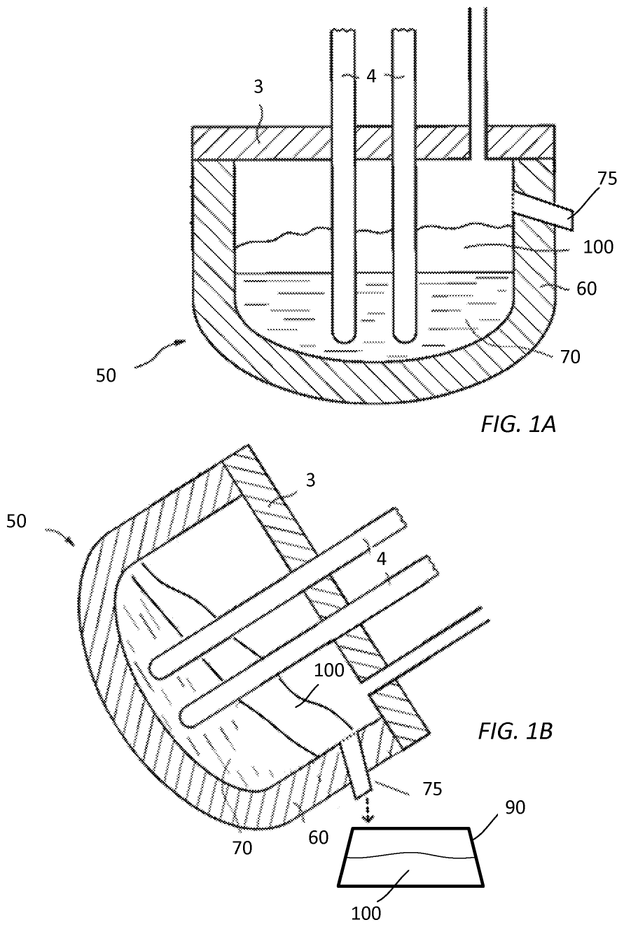

Referring now to FIG. 1B, therein illustrated is an exemplary schematic representation of slag 100 separation from molten bath 70 in an electric arc furnace 50 comprising a vessel 60, roof 3, electrodes 4 and slag drain port 75. Referring now to FIG. 1B, therein illustrated is a schematic representation furnace 50 positioned to drain or tip slag 100 from molten bath 70 into collector 90.

### Chemical Composition of Steel Slag

Slag compositions vary. Steel slag can vary compared to ladle slag with respect to oxides of iron, calcium, magnesium and silicon. Steel slag can vary based on it source and the product produced by the mill. For example, typical slag composition from an EAF can vary with respect to oxides of iron, calcium, magnesium and silicon depending on whether sheet or bars are cast. Likewise, ladle slag can vary based on it source and the product produced by the mill

Exemplary (partial) chemical compositions of slag (steel slag and ladle slag by % weight) are provided below in Table 1 for EAF steel slag from sheet and bar mills, and in Table 2 for ladle slag from sheet and bar mill production, respectively.

TABLE 1
Exemplary EAF steel slag Composition

| | Sheet Mills | Bar Mills |
|---|---|---|
| | Wt. % | Wt. % |
| MgO | 11.6 | 12.5 |
| Al₂O₂ | 4.5 | 6.0 |
| SiO₂ | 12.6 | 17.0 |
| CaO | 28.5 | 32.5 |
| MnO | 3.2 | 4.5 |
| FeOx | 37.2 | 25.0 |
| other | Remainder | Remainder |
| | to total 100% | to total 100% |

TABLE 2
Exemplary Ladle Slag Composition

| | Sheet Mills | Bar Mills |
|---|---|---|
| | Wt. % | Wt. % |
| MgO | 5.0 | 11.8 |
| Al₂O₂ | 34.0 | 4.0 |
| SiO₂ | 2.0 | 32.0 |
| CaO | 56.0 | 45.0 |
| MnO | 0.2 | 1.5 |
| FeOx | 0.5 | 1.0 |
| other | Remainder | Remainder |
| | to total 100% | to total 100% |

In one example, slag useful in the presently disclosed methods has a free lime (calcium hydroxide and calcium oxide) content less than about 60% by weight, less than about 50% by weight, less than about 30% by weight, or less than or equal to about 25% by weight by chemical composition.

In one example, the slag useful in the presently disclosed methods has a cumulative magnesium content of at least about 5% by weight, at least about 7% by weight, at least about 10% by weight, or at least about 15% by weight.

In one example, the slag has a SiO₂ content of at least about 1% by weight, at least about 2% by weight, at least about 3% by weight, at least about 5% by weight, at least about 7% by weight, at least about 10% by weight, at least about 15% by weight, at least about 20% by weight, at least about 25% by weight at least about 30% by weight, or at least about 35% by weight.

### Preparation of the Slag

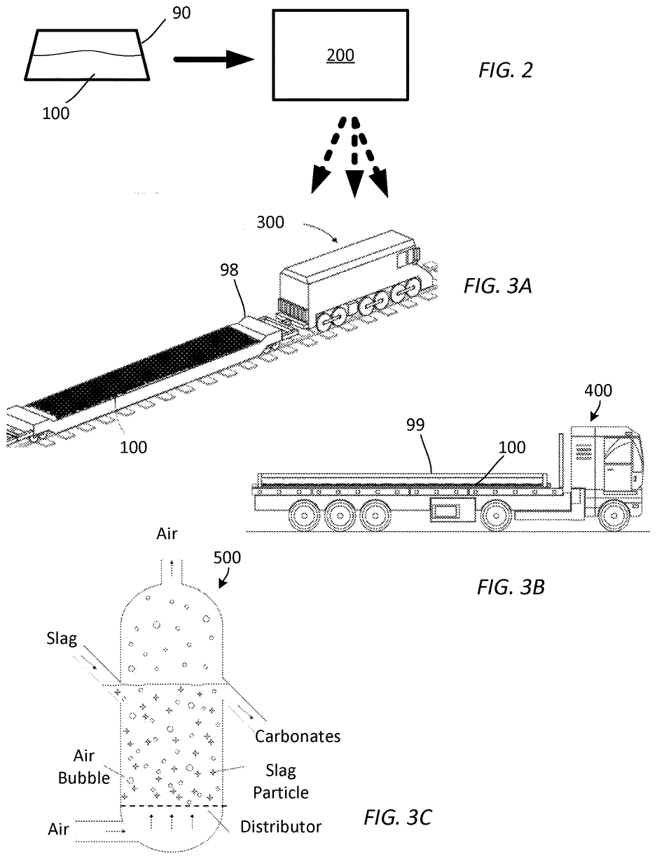

Referring now to FIG. 2, an exemplary CO₂ direct capture only (no SCM recovery) set-up illustration is shown where slag 100 in collector 90 is transported to preparation unit 200. In one example, slag 100 is prepared by crushing, pulverizing, or milling to a desired size or size distribution in preparation unit 200. In one example, slag 200 is crushed, pulverizing, or milled, and sieved in preparation unit 200. In one example, a filtering process or equivalent process may be used to separate fine slag pieces from coarse slag pieces. In one example, a coarse slag pieces are recycled and further crushed, pulverizing, or milled and/or sieved in preparation unit 200. In one example, water is introduced to the slag while in preparation unit 200.

In one example, the slag is prepared in preparation unit 200 prior to contact with the gaseous mixture. In one example, slag 100 is washed and/or filtered to separate fine slag pieces from coarse slag pieces. In some exemplary examples, coarser pieces of slag are pulverized while fine pieces of slag are not pulverized. In one example, for EAF steel slag, slag 100 may be pulverized in a pulverizer or other milling equipment, e.g. high pressure grinding or sonic milling. In one example, slag 100 is used for direct capture after pulverizing or milling to a desired size in preparation unit 200.

Thus, with reference to FIGS. 3A, 3B, and 3C, exemplary direct capture methods are illustrated. In one example, slag 100 is semi-continuously or continuously presented to a surface, such as a flatbed and is left exposed to the atmosphere for a time so as to convert at least a portion of the CO₂ from the atmosphere to carbonates by reaction of air comprising CO₂ with slag 100. In one example, freight car 98 of locomotive 300, or bed 99 of tractor trailer 40 provide a surface for prepared slag 100 and for CO₂-comprising gas to be introduced.

In one example, water is introduced to slag 100 after being deposited on a flatbed and before or during exposure to the atmosphere. In one example, air is blown over the surface of slag 100 while on flatbed 98, 99, or flatbed 98, 99 is put in motion to provide for a flow of air to be introduced to slag 100.

In one example, as illustrated in FIG. 3C, a fluidized bed reactor 500 is used as a reaction vessel. In one example, the CO₂-comprising gas, e.g., air, is injected into the fluidized bed reactor comprising fluidized prepared slag 100. In one example, the air velocity is adjusted to create a fluidized state, where the solid slag particles are lifted and mixed with air by the air stream. In one example, the air is heated, either internally or externally, to provide a required temperature for the chemical reactions between the CO₂ and slag 100 to occur. In one example, fluidized bed is configured to operate in different modes, such as bubbling, turbulent, or circulating. In one example, water is introduced to fluidized bed reactor 500. In one example, slag 100 is wet prior to entering fluidized bed reactor 500. Carbonates resulting from the reaction of CO₂ from the CO₂-comprising gas (e.g., air) and the prepared slag exiting fluidized bed reactor 500 and can be separated from the slag, collected, and transported. Alternatively the carbonates can be converted back to CO₂ using know methods and the CO₂ sequestered.

In one example, additional material is introduced to slag 100 before or after the slag is prepared. The slag may be finer or coarser than the additional material. In one example, the combined slag and additional material is further mixed with an amount of water. The additional material may already have some water content present and/or additional water may be introduced. The amount of water mixed with the combined slag and additional material will vary depending on the type of additional material. The slag may be provided within the mixture of slag, additional material, and water so that the steel slag constitutes at least 10%, at least 20%, at least 30%, at least 40%, at least 50%, at least 60%, at least 70%, at least 80%, at least 90% or more of the total mass of the mixture.

The slag can be reduced in size or sieve by any conventional method, for example, milling, and can be provided in an average particle size of 0.1 micron to 5000 micron. The particles of steel slag can be in any distribution of particle sizes, e.g., mono-modal, bi-modal, or multi-modal.

Coarser slag may not completely capture carbon dioxide from air as compared to finer slag. In one example, average size distribution of the slag is 1000 microns and less, 500 microns and less, 200 microns and less, 200 microns and less, 100 microns and less, 50 microns and less, or 25 microns and less.

In one example, the presently disclosed method provides for removal of about 50 weight % of CO₂ per weight of slag (e.g., 1 kg of slag captures 50 grams of carbon dioxide) about 10 weight % of CO₂ per weight of slag, about 15 weight %, about 20 weight %, or about 25 weight % of CO₂ per weight of slag from the CO₂-comprising gas.

### Concentration of CO₂ During Slag Mineralization

In examples, reheat furnace stack gas in an EAF Steelmaking process is used to introduce CO₂ to the slag. In examples, reheat furnace stack gas in an EAF Steelmaking process is used to introduce CO₂ to the slag during high intensity mixing for a “one vessel” CO₂ mineralization process. In examples, the amount of CO₂ presented to the slag, during high intensity mixing, is about 1-10 wt. %. In examples, the amount of CO₂ presented to the slag, during high intensity mixing, is about 2-8 wt. %. In examples, the amount of CO₂ presented to the slag, during high intensity mixing, is about 3-6 wt. %. Slag carbonization rates are generally observed to be unaffected by varying CO₂ concentrations in the stack gas.

In examples, CO₂-containing gas at a temperature of ambient or higher is introduced to the slag prior to and/or during high intensity mixing. In examples, the CO₂-containing gas is reheat furnace stack gas from an EAF Steelmaking process. In examples, CO₂-containing gas is reheat furnace stack gas that is introduced to the slag prior to and/or during high intensity mixing at a temperature of about 30-50° C. In examples, CO₂-containing gas is reheat furnace stack gas that is introduced to the slag prior to and/or during high intensity mixing at a temperature of less than 50° C. In examples, CO₂-containing gas is reheat furnace stack gas that is introduced to the slag prior to and/or during high intensity mixing at a temperature of about 30-50° C.

Slag Carbonation with SCM Production

In examples, high pressure grinding or sonic milling technologies provides low electric power consumption in slag grinding and reduces overall slag mineralization economics. In examples, slag material is introduced between two rotating rollers/tyres, one of which is in a fixed position and another roller/tyre that is floating. In examples, grinding equipment without grinding media (steel balls, etc.) is used. In examples, High Pressure Grinding Roll (HPGR) equipment is used. In examples, a HPGR unit sold by Weir Group PLC is used. In examples, the HPGR is coupled to a cyclonic separator, such as disclosed in U.S. Pat. No. 11,806,731 to Weir Minerals Africa Pty. Ltd., where slag and furnace stack gas can be manipulated into two different overflow outputs with different particle size distributions, and at least one output can be directed to the HPGR.

In examples, a pulse wave sonic milling with natural resonance disintegration (NRD)/comminution of the slag is performed. In examples, a NRD Internal mill unit sold by PulseWave Holding, Inc. is used.

Slag contains calcium silicates which can be converted to calcium silicate hydrates and calcium carbonates upon exposure to carbon dioxide in the air. The reactions of di-calcium silicate (C2S) and tri-calcium silicate (C3S) with CO₂ are described respectively by the following Equations (1) and (2):

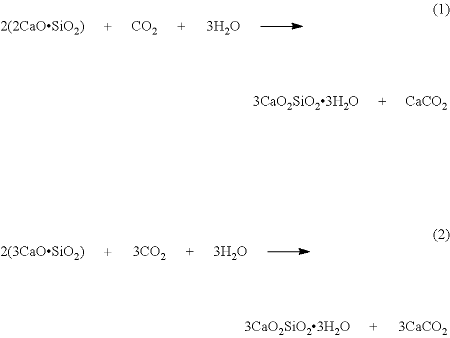

As slag carbonation is a CO₂ uptake process, carbon dioxide from the air and/or stack gas is sequestered through mineral precipitation in the slag as a result of the present disclosure, resulting in a direct reduction in CO₂ present in or released to the atmosphere. In one example, gaseous CO₂ is converted/sequestered into a non-gaseous carbonaceous product. Air or stack gas used in the present process, after contact with the slag, can be released to the atmosphere or recycled with reduced CO₂ content.

### Advantages of the Presently Disclosed Process

Among many advantages of the presently disclosed process, the following are of note:
Increasing the crystallinity of components of the slag particles being carbonated;
Increasing the relative humidity in direct carbonation processes using readily available CO₂-containing sources with moisture content;
Reducing the average particle size of slag particles being carbonated using high pressure grinding or sonic milling;
Optimized factors for increasing CO₂ mineralization rate in converting EAF steel slag to SCM's at the lowest energy penalty;
Leveraging steel slag CO₂ sequestration so as to provide economic, environmental, and social advantages, included, but not limited to:
Economical carbon capture: via steel slag reuse that reduces the necessity of establishing new carbon capture facilities, thereby reducing the overall total costs of CO₂ sequestration;
Waste valorization as carbonation provides a means of valorizing an industrial waste product, contributing to a circular economy, and promoting sustainable practices;
Carbon-negative potential: through the CO₂-to-slag carbonation process, waste can be used as a carbon sink, effectively sequestrating and immobilizing CO₂ that provides a carbon-negative aspect to contribute to broader climate change mitigation efforts;
Technologically feasible and energy-efficient: the presently disclosed process is e relatively simple, cost-effective, and technologically feasible;
Adaptability to existing infrastructure: the presently disclosed process can be integrated to existing steel mill infrastructure, minimizing the need for significant modifications or new construction;
Improved leaching properties: the process of carbonation reduces heavy metal leaching from steel slag, reducing environmental impacts;
Reduced raw material needs: steel slag carbonation as presently disclosed reduces the demand for fresh raw materials, contributing to overall sustainability and resource efficiency;
Recovering value-added by-products: products derived from slag carbonation as presently disclosed can be reused and generate revenues;
Versatile applications of the obtained secondary materials: the presently disclosed process carbonation process improves the properties of steel slag, making it more appropriate for use as aggregates in various construction applications, thus contributing to sustainable building practices;
Reduced environmental footprint: the on-site utilization of secondary materials derived from the presently disclosed carbon dioxide sequestration reduces the need for transporting materials over long distances, minimizing the environmental footprint associated with transportation; and/or.

Community and stakeholder acceptance: the presently disclosed process may encounter greater community and stakeholder acceptance compared to establishing new carbon capture facilities.

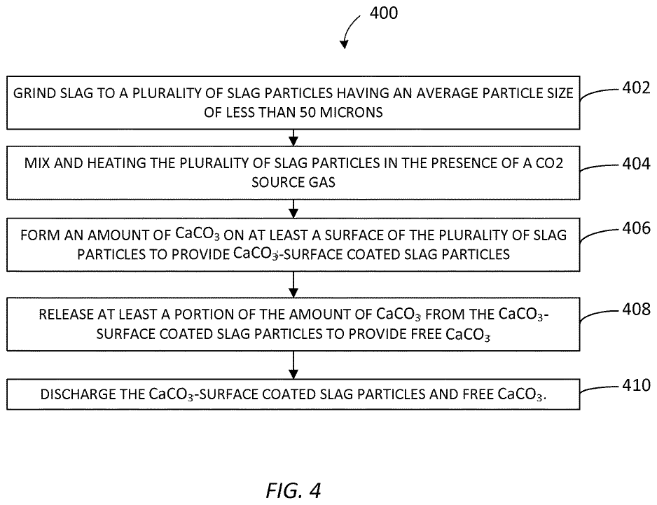

FIG. 4 is a flowchart of an example process 400 where slag is carbonated and SCM material is recovered. Such processes, as presently disclosed, can be preformed in batch mode, semi-continuous mode, or continuous mode.

In examples, one or more process blocks of FIG. 4 may be performed by a device. Process 400 may include additional implementations such as any single implementation or any combination of implementations described below and/or in connection with one or more other processes described elsewhere herein. In a first implementation, the magnetic removal of ferrous material is performed during grinding or prior to the mixing and heating.

Although FIG. 4 shows example blocks of process 400, In examples, process 400 may include additional blocks, fewer blocks, different blocks, or differently arranged blocks than those depicted in FIG. 4. Additionally or alternatively, two or more of the blocks of process 400 may be performed in parallel. In step 402 slag is ground to a plurality of slag particles having an average particle size of less than 50 microns. In step 404, the plurality of slag particles are mixed in the presence of a CO₂ source gas, for example a Stack Gas from an EAF process. In step 406, an amount of CaCO₂ is formed on at least a surface of the plurality of slag particles to provide CaCO₂-surface coated slag particles. In step 408, at least a portion of the amount of CaCO₂ from the CaCO₂-surface coated slag particles is released to provide free CaCO₂. In step 410, the CaCO₂-surface coated slag particles and free CaCO₂ are discharged from the mixer. In examples, magnets are employed to remove ferrous materials from the discharge.

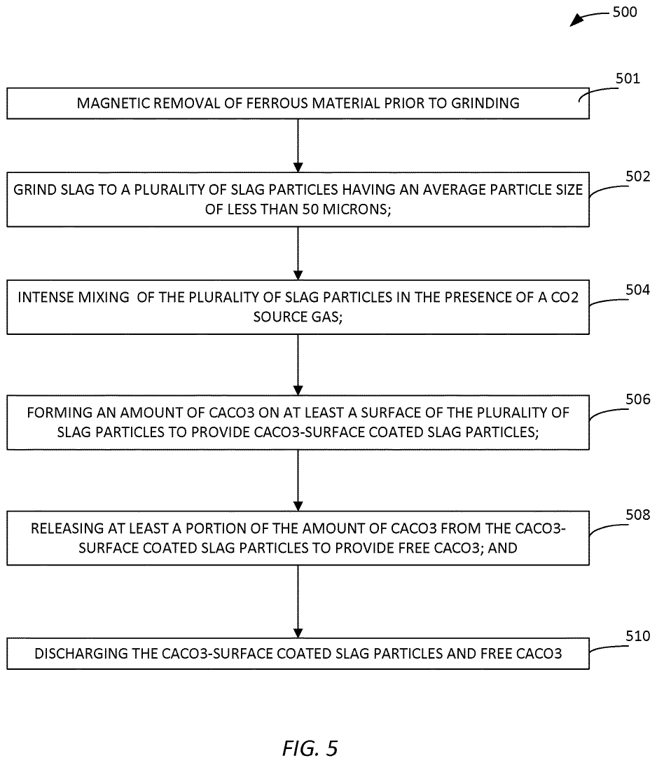

FIG. 5 is a flowchart of an example process 500, which includes an addition step 501 of removing ferrous material using a magnetic separator. In examples, one or more process blocks of FIG. 5 may be performed by a device. As shown in FIG. 5, process 500 may include a process for providing supplementary cementing material from slag (block 502). For example, a device may perform a process for providing supplementary cement material from slag as described above. As also shown in FIG. 5, process 500 may include grinding slag to a plurality of slag particles having an average particle size of less than 50 microns (step 502), mixing and heating the plurality of slag particles in the presence of a CO₂ source gas (step 504), forming an amount of CaCO₂ on at least a surface of the plurality of slag particles to provide CaCO₂-surface coated slag particles (step 506), releasing at least a portion of the amount of CaCO₂ from the CaCO₂-surface coated slag particles to provide free CaCO₂ (step 508), and discharging the CaCO₂-surface coated slag particles and free CaCO₂ (step 510).

For example, a HPGR device may grind slag to a plurality of slag particles having an average particle size of less than 50 microns, the device configured to mix and heat the plurality of slag particles in the presence of a CO₂ source gas, form an amount of CaCO₂ on at least a surface of the plurality of slag particles to provide CaCO₂-surface coated slag particles, release at least a portion of the amount of CaCO₂ from the CaCO₂-surface coated slag particles to provide free CaCO₂, and discharge the CaCO₂-surface coated slag particles and free CaCO₂ as described above. In examples, magnets are employed to remove ferrous materials from the discharge.

Process 500 may include additional implementations such as any single implementation or any combination of implementations described below and/or in connection with one or more other processes described elsewhere herein. In a first implementation, the magnetic removal of ferrous material is performed during grinding or prior to the mixing and heating.

Although FIG. 5 shows example blocks of process 500, In examples, process 500 may include additional blocks, fewer blocks, different blocks, or differently arranged blocks than those depicted in FIG. 5. Additionally or alternatively, two or more of the blocks of process 500 may be performed in parallel.

In an exemplary process, EAF steel slag is ground to about 10 micron average particle size slag particulate using a two-stage HPGR device (Weir German Enduron) with magnetic particle remove of ferrous material for steel production recycle. A continuous flow of Reheat Stack Gas from an operating EAF unit is introduced to the slag particulate using a high intensity mixer (e.g., Eirich German R28 High Intensity Mixer) (“HPGR mixer”). In examples, a bottom plate of the HPGR mixer (not shown) is opened and the slag/CaCO₂ mixture is discharged. In examples, the discharged slag/CaCO₂ mixture is suitable as-is for use as a SCM. In examples, the discharged slag/CaCO₂ mixture is reprocessed by re-introduction to the HPGR.

The Reheat Stack Gas, with about 4-6 wt. % CO₂ is cooled to a temperature of about 30 C before introduction to the slag particulate. The Stack Gas is injected into the high intensity mixer using a slotted pipe through the top of the mixer. CO₂-depleted Stack Gas is exhausted from the mixer using a pressure valve and is introduced to a Cyclone to remove particles of predetermined sizes. SCM material is discharged from an opening at the bottom of the mixer.

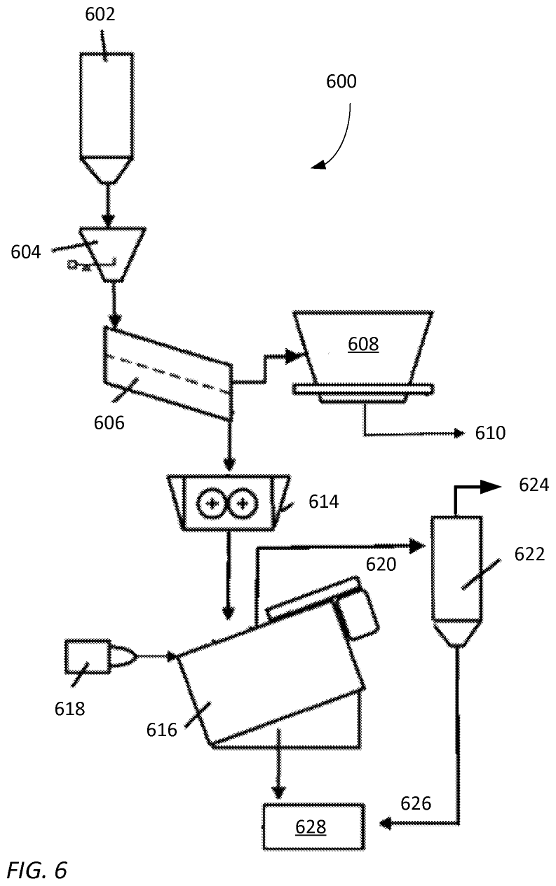

FIG. 6 is a diagrammatic view of an exemplary process 600 according to the present disclosure, where EAF steel slag is introduced to slag hopper 602. EAF steel slag can be weighed and/or sieved to a desired amount and average particle size in unit 604. Sieved EAF steel slag is then presented to magnetic separator 606 to remove ferrous materials, which are recycled with scrap steel for use in the EAF. Ferrous material removed from slag is collected in recycle unit 608 and recycled to EAF 610. Slag with ferrous material removed is then introduced to grinder/mill 614 to further reduce the slag to an average particle size of about 25 microns. Ground/milled slag is then introduced to high intensity mixer 616 which has stack gas feed 618 for introducing CO₂ and water vapor with slag in mixer 618. Residual stack gas and fines 620 are introduced to cyclone separator 622 where stack gas 624 is returned to source and fines 626 are combined with SCM material 626 exiting mixer 616.

As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

We claim:

1. A process for providing supplementary cementing material from slag, the process comprising:
grinding slag to a plurality of slag particles having an average particle size of less than 50 microns;
mixing and heating the plurality of slag particles in the presence of a CO₂ source gas;
forming an amount of CaCO₂ on at least a surface of the plurality of slag particles to provide CaCO₂-surface coated slag particles;
releasing at least a portion of the amount of CaCO₂ from the CaCO₂-surface coated slag particles to provide free CaCO₂; and
discharging the CaCO₂-surface coated slag particles and free CaCO₂.

2. The process of claim 1, further comprising magnetic removal of ferrous material.

3. The process of claim 1, wherein the magnetic removal of ferrous material is preformed prior to the grinding.

4. The process of claim 1, further comprising direct capture of at least a portion of the CO₂ source gas.

5. The process of claim 1, wherein the CO₂ source gas is atmospheric air, compressed air, or exhaust gas from combustion of a hydrocarbon fuel.

6. The process of claim 1, wherein the slag is a steel slag, a ladle slag, an EBH slag, or combinations thereof.

7. The process of claim 1, wherein the slag comprises at least about 20% by weight of calcium oxide.

8. The process of claim 1, wherein the slag comprises between about 5 to 20% by weight of magnesium oxide.

9. The process of claim 1, wherein the slag comprises at least about 4% by weight of SiO₂.

10. The process of claim 1, wherein the slag comprises a weight ratio of calcium oxide to FeOx of between about 1:1 to 50:1.

11. The process of claim 1, wherein the slag is pulverized or milled to an average particle size of between 1-50 microns.

12. The process of claim 1, further comprising removing a metal carbonate SCM reaction product.

13. An apparatus for providing SCM and/or removing at least a portion of CO₂ from a CO₂ source gas, the apparatus comprising, in combination:
(a) a device configured to introduce the CO₂ source gas to a slag; and
(b) a device configured to recovery a reaction product of the slag with the CO₂ source gas.

14. The apparatus of claim 13, wherein the device of step (a) is operatively coupled to a steel manufacturing operation.

15. The apparatus of claim 13, wherein the slag is a steel slag.

16. The apparatus of claim 13, wherein the slag comprises at least about 20% by weight of calcium oxide.

17. The apparatus of claim 13, wherein the slag comprises between about 5 to 20% by weight of magnesium oxide.

18. The apparatus of claim 13, wherein the slag comprises at least about 4% by weight of SiO₂.

19. The apparatus of claim 13, wherein the slag comprises a weight ratio of calcium oxide to FeOx of between about 1:1 to 50:1.

20. The apparatus of claim 13, further comprising a device configured to pulverize or mill the slag and/or further comprising a device configured to further introduce water to the slag.
